(19) United States
(12) Patent Application Publication
(10) Pub. No.: US 2018/0170780 A1
(43) Pub. Date: Jun. 21, 2018

(54) PROCESSING METHOD FOR WASTE HYDROGEN PEROXIDE AQUEOUS SOLUTION THAT HAS A CONCENTRATION FROM 0.5% TO 90%

(71) Applicant: MARKETECH INTERNATIONAL CORP., Nangang District Taipei (TW)

(72) Inventors: Ming-Ying LEE, Tainan County (TW); Chien-Kuo LU, Hsinchu City (TW); Yau-Lang TSAI, Hsinchu City (TW)

(73) Assignee: MARKETECH INTERNATIONAL CORP., Nangang District Taipei (TW)

(21) Appl. No.: 15/645,084

(22) Filed: Jul. 10, 2017

(30) Foreign Application Priority Data
Dec. 16, 2016 (TW) 105141701

(51) Int. Cl. C02F 3/34

(52) U.S. Cl. CPC C02F 3/342; C02F 2101/10

(57) ABSTRACT

A processing method of hydrogen peroxide aqueous solution includes the following steps. Base on a high catalytic trait of the catalase mixing aqueous solution relative to the hydrogen peroxide, aqueous solution and catalase mixing aqueous solution are provided into a semi-batch reactor that has a fixed capacity. Hydrogen peroxide aqueous solution/hydrogen peroxide aqueous solution with catalase is added into the semi-batch reactor, wherein the concentration of the hydrogen peroxide aqueous solution is from 0.5% to 90%. The hydrogen peroxide aqueous solution and the catalase mixing aqueous solution are reacted in the semi-batch reactor, and transformed into catalase mixing aqueous solution and hydrogen peroxide aqueous solution that has a concentration lower relative to the original concentration to effectively reduce the warming ratio and the boosting ratio of the semi-batch reactor for safely and effectively processing the hydrogen peroxide aqueous solution having a concentration from 0.5% to 90%.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

### 1. Field of the Invention

The present invention relates to a processing method, and more particularly to a processing method for waste hydrogen peroxide aqueous solution that has a concentration from 0.5% to 90%.

### 2. Description of Related Art Including Information Disclosed Under 37 CFR 1.97 And 37 CFR 1.98

Nowadays, electronics industry often uses the hydrogen peroxide (H₂O₂) in the semi-conductor manufacturing processes. Consequently, the waste water from the semi-conductor manufacturing processes contains hydrogen peroxide in a certain percentage. Some waste hydrogen peroxide aqueous solution even has a hydrogen peroxide concentration over 10%. The high concentration hydrogen peroxide aqueous solution has a high activity and corrosivity such that the concentration of the hydrogen peroxide needs to be effectively reduced for stored or recycling the subsidiary matter.

$${H}_{2} {O}_{2 ( sq )} {H}_{2} {O}_{( i )} + \frac{1}{2} {O}_{2 ( g )}$$

The heat of reaction of the above chemical formula may achieve 98 KJ/mole. Consequently, the electronics industry cannot effectively, quickly and safely process the hydrogen peroxide aqueous solution when the hydrogen peroxide aqueous solution has a concentration over 0.5%. A conventional apparatus for process the hydrogen peroxide aqueous solution is a small apparatus and can be continually operated and process the hydrogen peroxide aqueous solution. The conventional apparatus decompose the hydrogen peroxide aqueous solution into water and oxygen by contacting the hydrogen peroxide decomposition catalyst with the hydrogen peroxide aqueous solution. The conventional apparatus for processing the hydrogen peroxide aqueous solution is filled with hydrogen peroxide decomposition catalyst and has an inlet, an outlet and a gas-liquid separator. The gas-liquid separator has a cylinder structure, wherein an upper portion of the gas-liquid separator is connected to a gas exhaust pipe and a lower portion connected to a water exhaust pipe.

The hydrogen peroxide decomposition catalyst of the above apparatus uses a carrier for loading platinum family metal, wherein a diameter of the colloid nanoparticle of the platinum family metal is 1˜50 nm, the carrier is ion-exchange resin and the hydrogen peroxide concentration in the exhausted water is 0.1˜5 weight percent.

The present invention has arisen to mitigate and/or obviate the disadvantages of the conventional hydrogen peroxide aqueous solution processing apparatus.

### BRIEF SUMMARY OF THE INVENTION

The main objective of the present invention is to provide an improved processing method for waste hydrogen peroxide aqueous solution that has a concentration from 0.5% to 90%.

To achieve the objective, processing method for waste hydrogen peroxide aqueous solution that has a concentration from 0.5% to 90% in accordance with the present invention comprises the following steps:

A. aqueous solution and the catalase previously added into a semi-batch reactor that has a fixed capacity for forming catalase mixing aqueous solution;

B. hydrogen peroxide aqueous solution with a concentration from 0.5% to 90% and the catalase respectively added into the semi-batch reactor at the same time; and

C. the hydrogen peroxide aqueous solution chemically reacted with the catalase after being diluted with the aqueous solution for effectively removing the hydrogen peroxide in the hydrogen peroxide aqueous solution and forming water, oxygen and thermal energy, the semi-batch reactor selectively stopped when at least one of a pressure value, a temperature value and a concentration value of the hydrogen peroxide in the semi-batch reactor is over a pre-set value.

Further benefits and advantages of the present invention will become apparent after a careful reading of the detailed description with appropriate reference to the accompanying drawings.

### BRIEF DESCRIPTION OF THE SEVERAL VIEWS OF THE DRAWINGS

FIG. 1 is a flow chart of a first embodiment of a processing method for waste hydrogen peroxide aqueous solution that has a concentration from 0.5% to 90% in accordance with the present invention.

FIG. 2 is an operational view of the first embodiment of the processing method for waste hydrogen peroxide aqueous solution.

FIG. 3 is a is a flow chart of a second embodiment of the processing method for waste hydrogen peroxide aqueous solution that has a concentration from 0.5% to 90% in accordance with the present invention.

FIG. 4 is an operational view of the second embodiment of the processing method for waste hydrogen peroxide aqueous solution.

FIG. 5 is a flow chart of a third embodiment of the processing method for waste hydrogen peroxide aqueous solution that has a concentration from 0.5% to 90% in accordance with the present invention.

FIG. 6 is an operational view of the third and a fourth embodiment of the processing method for waste hydrogen peroxide aqueous solution.

FIG. 7 is a flow chart of a fourth embodiment of the processing method for waste hydrogen peroxide aqueous solution that has a concentration from 0.5% to 90% in accordance with the present invention.

### DETAILED DESCRIPTION OF THE INVENTION

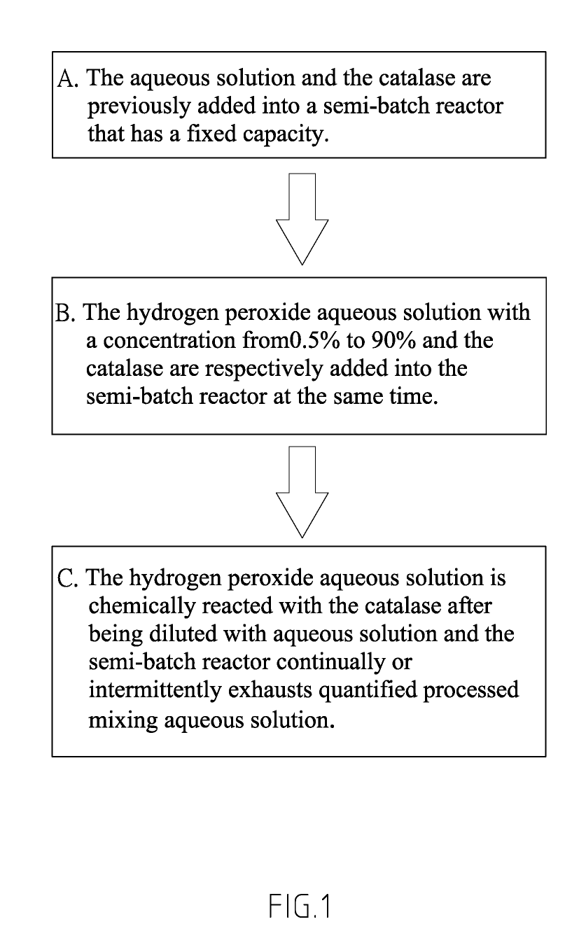

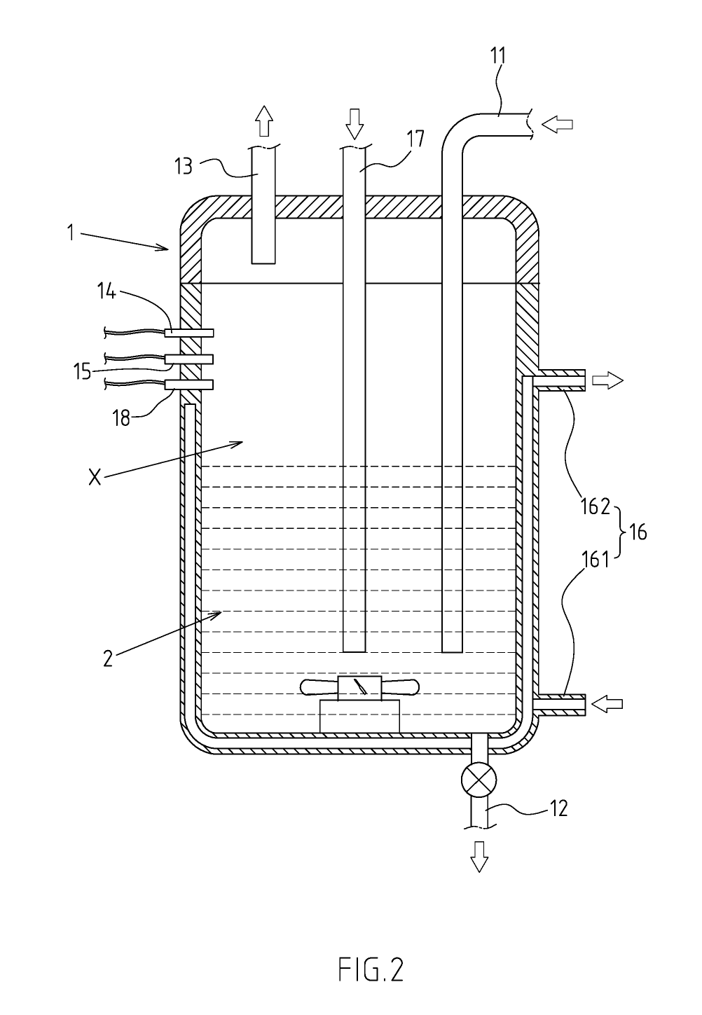

Referring to the drawings and initially to FIGS. 1 and 2, a processing method for hydrogen peroxide aqueous solution that has a concentration from 0.5% to 90% in accordance with the present invention comprises the following steps. Hereinafter, the hydrogen peroxide aqueous solution, in the specification, has a concentration from 0.5% to 90%.

The processing method in accordance with the present invention comprises the following steps.

A. Aqueous solution and catalase are added into a semi-batch reactor 1 that has a fixed capacity X. In the preferred embodiment of the present invention, the fixed capacity X of the semi-batch reactor 1 is 1000 ml and the aqueous solution is pure water. The adding amount of the aqueous solution and the catalase is from 10 vol % to 90 vol % relative to the capacity X of the semi-batch reactor 1, wherein the, in the specification, the vol % is volume percentage. The aqueous solution and the catalase is mixed to form catalase mixing aqueous solution 2, wherein the adding amount of the catalase mixing aqueous solution 2 is 100 ml to 900 ml and the adding concentration of the catalase is 0.05 vol % to 2 vol % relative to the catalase mixing aqueous solution 2.

In the preferred embodiment of the present invention, the adding amount of the catalase mixing aqueous solution 2 is 200 ml and the adding concentration of the catalase is 0.1 vol % relative to the catalase mixing aqueous solution 2. A hydrogen peroxide aqueous solution inlet port 11, a mixing aqueous solution outlet port 12, an exhaust port 13, a pressure sensor 14, a temperature sensor 15, a water-cooled radiator 16, a catalase inlet port 17 and a hydrogen peroxide concentration sensor 18 are respectively disposed on the semi-batch reactor 1. The hydrogen peroxide aqueous solution inlet port 11 is provided for adding hydrogen peroxide aqueous solution into the semi-batch reactor 1, wherein the hydrogen peroxide aqueous solution has a concentration from 0.5% to 90%. The mixing aqueous solution outlet port 12 is provided for exhausting the processed mixing aqueous solution from the semi-batch reactor 1, wherein the processed mixing aqueous solution contains little catalase and hydrogen peroxide. The exhaust port 13 is provided for exhausting the gas, such as oxygen etc., during processing. A relief valve is disposed on the exhaust port 13 to prevent the semi-batch reactor 1 from danger due to a high pressure. The pressure sensor 14 stops all the process procedures when sensing a pressure in the semi-batch reactor 1 is higher about 120% (17.64 psia) than a preset pressure value (14.7 psia). The semi-batch reactor 1 is restarted by manual reset when the pressure in the semi-batch reactor 1 is reduced to a safe pressure value. The temperature sensor 15 stops all the process procedures when sensing a temperature in the semi-batch reactor 1 is higher about 120% (36° C.) than a preset temperature value (30° C.). The semi-batch reactor 1 is restarted by manual reset when the temperature in the semi-batch reactor 1 is reduced to a safe temperature value. The preferred processing temperature is set from 15° C. to 45° C. The hydrogen peroxide concentration sensor 18 is provided for sensing the concentration of the hydrogen peroxide in the semi-batch reactor 1 and automatically stops the process procedures when the concentration of the hydrogen peroxide in the semi-batch reactor 1 is over 0.25%. In the preferred embodiment of the present invention, the concentration of the hydrogen peroxide is controlled under 0.125%. The water-cooled radiator 16 includes a blast hole 161 and a drain outlet 162 respectively defined in the semi-batch reactor 1 for reducing the temperature in the semi-batch reactor 1 during processing the hydrogen peroxide aqueous solution. The catalase is added into the semi-batch reactor 1 via the catalase inlet port 17.

B. Catalase and hydrogen peroxide aqueous solution with a concentration from 0.5% to 90% are respectively and continually provided into the semi-batch reactor 1 at the same time, wherein the concentration of the hydrogen peroxide aqueous solution is controlled under 36%. For example, if 1 ml catalase can process 1000 ml hydrogen peroxide aqueous solution, the adding speed of the catalase is 0.05% to 2% relative to an adding speed of the hydrogen peroxide aqueous solution. In the preferred embodiment of the present invention, the adding speed of the hydrogen peroxide aqueous solution is 5 ml/min such that the adding speed of the catalase is 0.0025 ml/ to 0.1 ml/min. For example, the catalase is added into the semi-batch reactor 1 through the catalase inlet port 17 and the hydrogen peroxide aqueous solution is added into the semi-batch reactor 1 through the hydrogen peroxide aqueous solution inlet port 11. The addition of the hydrogen peroxide aqueous solution is set from 0.01 vol %/min to 2 vol %/min relative to the capacity X of the semi-batch reactor 1 when the adding speed of the catalase is 0.005 ml/min. In the preferred embodiment of the present invention, the addition of the hydrogen peroxide aqueous solution is 5 ml/min.

C. The hydrogen peroxide aqueous solution is chemically reacted with the catalase after being diluted with aqueous solution and the semi-batch reactor 1 continually or intermittently exhausts quantified processed mixing aqueous solution. The hydrogen peroxide aqueous solution in the semi-batch reactor 1 is diluted to a low concentration hydrogen peroxide aqueous solution with the catalase mixing aqueous solution 2 in the semi-batch reactor 1. Based on the high catalytic characteristic of the catalase for processing the hydrogen peroxide aqueous solution, the low concentration hydrogen peroxide aqueous solution is chemically reacted with the catalase in the catalase mixing aqueous solution 2 and forming water, oxygen and thermal energy. The formed oxygen is exhausted via the exhaust port 13. The formed thermal energy is absorbed for reducing the temperature of the semi-batch reactor 1 during processing the hydrogen peroxide aqueous solution when the condensate flows into the water-cool radiator 16 via the blast-hole 161 and is exhausted via the drain outlet 162. At any time, the pressure sensor 14, the temperature sensor 15 and the hydrogen peroxide concentration sensor 18 are used to detect the pressure, the temperature and the concentration is the semi-batch reactor 1 during reacting for ensuring the safety of the chemical reaction procedures. The water, which is formed during the chemical reaction, is mixed with the catalase mixing aqueous solution 2. Consequently, the processed mixing aqueous solution (containing little catalase and hydrogen peroxide) in the semi-batch reactor 1 is exhausted via the mixing aqueous solution outlet port 12 and the aqueous solution amount in the semi-batch reactor 1 is maintained about 200 ml when adding the hydrogen peroxide aqueous solution.

The above processing procedures in accordance with the present invention accord to a mode named “continually in, continually or intermittently out” that is one of the preferred embodiments of the present invention. The hydrogen peroxide aqueous solution and the catalase are respectively added into the semi-batch reactor 1 and the mixing aqueous solution in the semi-batch reactor 1 is continually or intermittently exhausted at the same time. Consequently, the processing procedures of the preferred embodiment can be continually operated without stopping the semi-batch reactor 1 for adding related aqueous solution. As a result, the processing effect of the hydrogen peroxide aqueous solution is promoted.

In this preferred embodiment, the capacity X of the semi-batch reactor 1 is adjusted in moderation for providing a buffer to the temperature and pressure of the reacting system. As a result, the heating rate and the boost rate of the semi-batch reactor 1 are effectively reduced for processing the hydrogen peroxide aqueous solution in a safe condition and respond to a required processing rate of the hydrogen peroxide aqueous solution that is prepared to be reacted.

Based on the high catalytic characteristic of the catalase for processing the hydrogen peroxide aqueous solution, the aqueous solution and the catalase are mixed and form a catalase mixing aqueous solution 2 in the semi-batch reactor 1 with a fixed capacity X. Then, the hydrogen peroxide aqueous solution and the catalase are added into the semi-batch reactor 1 such that the catalase mixing aqueous solution 2 and the hydrogen peroxide aqueous solution are chemically reacted to form catalase and hydrogen peroxide aqueous solution that has a low concentration relative to the original hydrogen peroxide aqueous solution. As a result, the heating rate and the boost rate of the semi-batch reactor 1 are effectively reduced for processing the hydrogen peroxide aqueous solution in a safe condition. Consequently, the above method prevents a lot of hydrogen peroxide aqueous solution from being directly reacted with the catalase mixing aqueous solution 2 and deriving an explode due to high temperature and high pressure. By using the high catalytic characteristic of the catalase for processing the hydrogen peroxide, even the concentration of the catalase is about 0.1%, the catalase still can be reacted with the diluted hydrogen peroxide aqueous solution and the concentration of the hydrogen peroxide aqueous solution in the semi-batch reactor 1 can be controlled under 0.25% that proves that the method in accordance with the present invention can be operated in a safe condition.

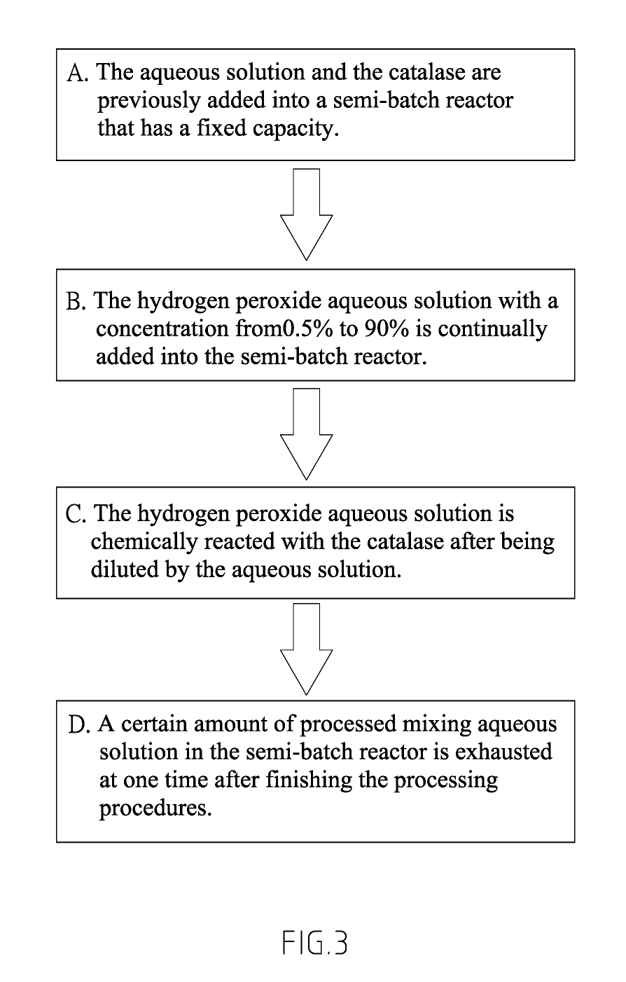

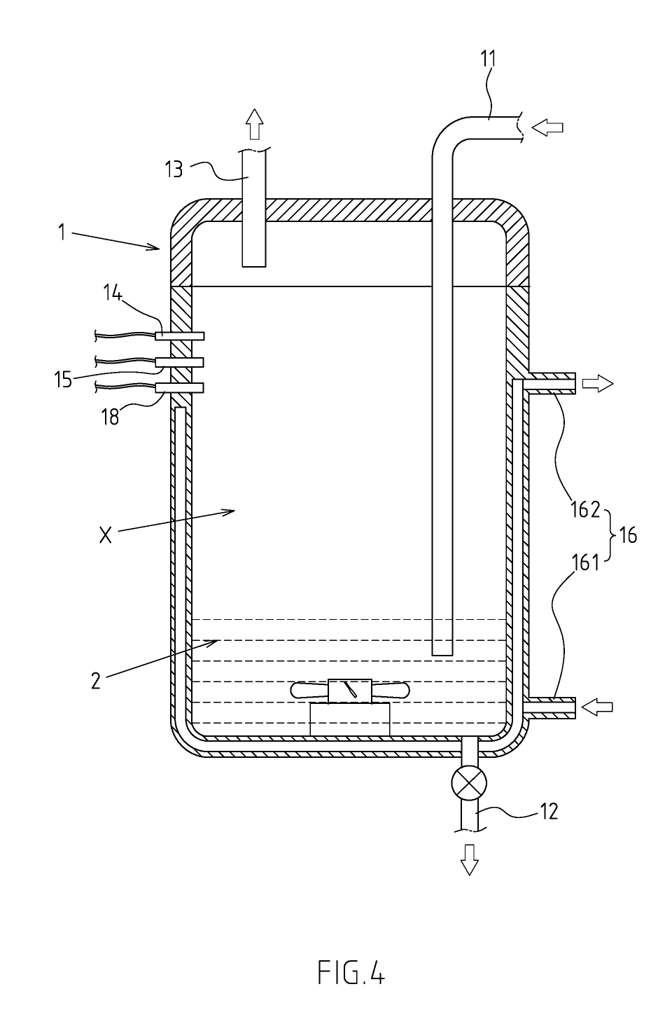

With reference to FIGS. 3 and 4 that show a second preferred embodiment of the method in accordance with the present invention, in this embodiment, the processing method in accordance with the present invention comprises the following steps.

A. Aqueous solution and catalase are added into a semi-batch reactor 1 that has a fixed capacity X. Based on the characteristic of the semi-batch reactor 1 having a fixed capacity, the aqueous solution and catalase are mixed and formed a catalase mixing aqueous solution in the semi-batch reactor 1. In the preferred embodiment of the present invention, the fixed capacity X of the semi-batch reactor 1, for example, is 1000 ml. The adding amount of the aqueous solution and the catalase is from 10 vol % to 90 vol % of the capacity X of the semi-batch reactor 1. The adding amount of the catalase is 0.05 vol % to 2 vol % relative to the capacity X of the semi-batch reactor. In the preferred embodiment of the present invention, the adding amount of the catalase mixing aqueous solution 2 is 200 ml and the adding amount of the catalase is 0.1 vol % relative to the capacity X of the semi-batch reactor 1, that is, the Adding amount of the catalase is 1 ml.

B. The hydrogen peroxide aqueous solution is continually added into the semi-batch reactor 1, wherein the adding rate of the hydrogen peroxide aqueous solution is 0.005 vol %/min to 2 vol %/min relative to the capacity X of the semi-batch reactor 1. In the preferred embodiment of the present invention, for example, the adding speed of the hydrogen peroxide aqueous solution is 5 ml/min and the hydrogen peroxide aqueous solution flows into the semi-batch reactor 1 via the hydrogen peroxide aqueous solution inlet port 11.

C. The hydrogen peroxide aqueous solution is chemically reacted with the catalase after being diluted with aqueous solution. The hydrogen peroxide aqueous solution in the semi-batch reactor 1 is diluted to a low concentration hydrogen peroxide aqueous solution with aqueous solution in the catalase mixing aqueous solution 2 and the low concentration hydrogen peroxide aqueous solution is chemically reacted with the catalase contained in the catalase mixing aqueous solution 2 to from water, oxygen and thermal energy. The formed oxygen is exhausted via the exhaust port 13. The formed thermal energy is absorbed for reducing the temperature of the semi-batch reactor 1 during processing the hydrogen peroxide aqueous solution when the condensate flows into the water-cool radiator 16 via the blast-hole 161 and is exhausted via the drain outlet 162. At any time, the pressure sensor 14, the temperature sensor 15 and the hydrogen peroxide concentration sensor 18 are used to detect the pressure, the temperature and the concentration is the semi-batch reactor 1 during reacting for ensuring the safety of the chemical reaction procedures.

D. A certain amount of processed mixing aqueous solution in the semi-batch reactor 1 is exhausted at one time after finishing the above steps. The water formed during processing the hydrogen peroxide aqueous solution is mixed with the catalase mixing aqueous solution. Consequently, it takes about 140 minutes for processing 700 ml hydrogen peroxide aqueous solution and it is set as a process procedure cycle when the mixed aqueous solution is 90 vol % relative to the capacity X of the semi-batch reactor 1. The processed aqueous solution, containing little catalase and hydrogen peroxide, is exhausted from the semi-batch reactor 1 via the mixing aqueous solution outlet port 12. The mixing aqueous solution outlet port 12 is closed and stops exhausting when the amount of the maintained aqueous solution is 20 vol % relative to the capacity X of the semi-batch reactor 1, that is, the amount of the maintained aqueous solution is 200 ml. Consequently, the operator only needs to add catalase without adding any aqueous solution and the next process procedure cycle can be operated, wherein the adding amount of the catalase is 0.07 vol % relative to the capacity X of the semi-batch reactor 1.

Based on the high catalytic characteristic of the catalase for processing the hydrogen peroxide aqueous solution, the aqueous solution and the catalase are mixed and form a catalase mixing aqueous solution 2 in the semi-batch reactor 1 with a fixed capacity X. Then, the hydrogen peroxide aqueous solution and the catalase are added into the semi-batch reactor 1 such that the catalase mixing aqueous solution 2 and the hydrogen peroxide aqueous solution are chemically reacted to form catalase and hydrogen peroxide aqueous solution that has a low concentration relative to the original hydrogen peroxide aqueous solution. As a result, the heating rate and the boost rate of the semi-batch reactor 1 are effectively reduced for safely processing the hydrogen peroxide aqueous solution. By using the high catalytic characteristic of the catalase for processing the hydrogen peroxide, even the concentration of the catalase is about 0.1%, the catalase still can be reacted with the diluted hydrogen peroxide aqueous solution and the concentration of the hydrogen peroxide aqueous solution in the semi-batch reactor 1 can be controlled under 0.25% that proves that the method in accordance with the present invention can be operated in a safe condition.

The above processing procedures in accordance with the present invention accord to a mode named “continually in, once out” that is one of the preferred embodiments of the present invention. The hydrogen peroxide aqueous solution is continually added into the semi-batch reactor 1 during processing procedures. The formed aqueous solution is exhausted when a process procedure cycle is finished and the amounted of the formed aqueous solution is 90 vol % relative to the capacity X of the semi-batch reactor 1. The exhausting step is stopped when the amount of the maintained aqueous solution is 20 vol % relative to the capacity X of the semi-batch reactor 1.

After processing several batches, the difference of total volume of each batch is small, that is, only the first batch needs to be added aqueous solution and the processed mixing aqueous solution is used as the necessary aqueous solution of the next batch. Based on the high catalytic characteristic of the catalase for processing the hydrogen peroxide aqueous solution, the chemical reaction of the catalase and the hydrogen peroxide aqueous solution that has a concentration from 0.5% to 90% is transformed as a chemical reaction of the catalase and the low concentration hydrogen peroxide aqueous solution. The Volume percentage of the adding amount of the aqueous solution according to the total process amount is gradually reduced relative number of the batch. After processing tens batches, The Volume percentage of the adding amount of the aqueous solution according to the total process amount is gradually reduced less than 1%.

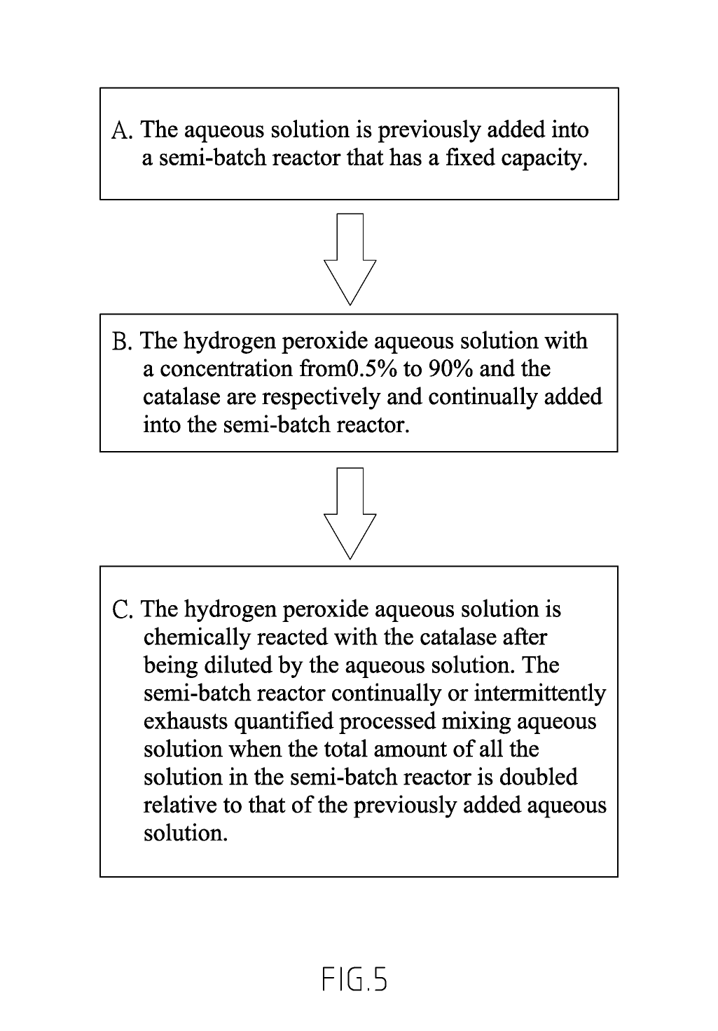

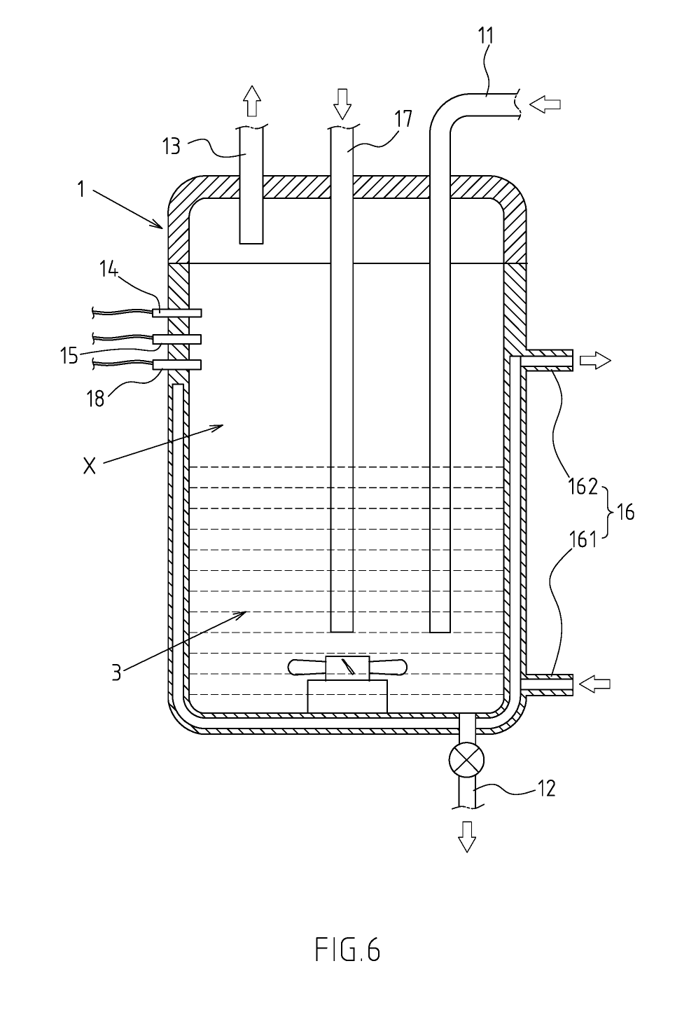

With reference to FIGS. 5 and 6 that show a third preferred embodiment of the method in accordance with the present invention, in this embodiment, the processing method in accordance with the present invention comprises the following steps.

A. Aqueous solution 3 is previously added into a semi-batch reactor 1 that has a fixed capacity X. In the preferred embodiment of the present invention, the fixed capacity X of the semi-batch reactor 1 is 1000 ml and the aqueous solution 3 is pure water. The adding amount of the aqueous solution 3 is from 10 vol % to 45 vol % relative to the capacity X of the semi-batch reactor 1. In the preferred embodiment of the present invention, the adding amount of the aqueous solution 3 is 200 ml. A hydrogen peroxide aqueous solution inlet port 11, a mixing aqueous solution outlet port 12, an exhaust port 13, a pressure sensor 14, a temperature sensor 15, a water-cooled radiator 16 and a catalase inlet port 17 are respectively disposed on the semi-batch reactor 1, wherein the water-cooled radiator 16 includes a blast hole 161 and a drain outlet 162.

B. Catalase and hydrogen peroxide aqueous solution with a concentration from 0.5% to 90% are respectively and continually provided into the semi-batch reactor 1 at the same time, wherein the adding speed of the catalase is 0.01% to 4% relative to an adding speed of the hydrogen peroxide aqueous solution in an early stage. In the preferred embodiment of the present invention, the adding speed of the catalase is 0.2% relative to an adding speed of the hydrogen peroxide aqueous solution in an early stage and the adding speed of the hydrogen peroxide aqueous solution is 5 ml/min and the adding speed of the catalase is 0.01 ml/min. The adding speed of the catalase is adjusted about 0.05% to 2% relative to that of the hydrogen peroxide aqueous solution when the total amount of all the solution in the semi-batch reactor 1 is doubled relative to that of the previously added aqueous solution 3. In the preferred embodiment of the present invention, the adding speed of the catalase is adjusted about 0.05% to 2% relative to that of the hydrogen peroxide aqueous solution when the total amount of all the solution in the semi-batch reactor 1 is doubled relative to that of the previously added aqueous solution 3. As a result, the adding speed of the hydrogen peroxide aqueous solution is reduced to 0.005 ml/min.

C. The hydrogen peroxide aqueous solution is chemically reacted with the catalase after being diluted by the aqueous solution 3. The semi-batch reactor 1 continually or intermittently exhausts quantified processed mixing aqueous solution when the total amount of all the solution in the semi-batch reactor 1 is doubled relative to that of the previously added aqueous solution 3. The hydrogen peroxide aqueous solution in the semi-batch reactor 1 is diluted to a low concentration hydrogen peroxide aqueous solution with the aqueous solution 3 in the semi-batch reactor 1. Based on the high catalytic characteristic of the catalase for processing the hydrogen peroxide aqueous solution, the low concentration hydrogen peroxide aqueous solution is chemically reacted with the catalase for removing the hydrogen peroxide in the hydrogen peroxide aqueous solution and forming water, oxygen and thermal energy. The mixing aqueous solution, containing little catalase and hydrogen peroxide, in the semi-batch reactor 1 is exhausted via the mixing aqueous solution outlet port 12 when the mixing aqueous solution in the semi-batch reactor 1 has an amount of 400 ml (doubled relative to the amount of the previously added aqueous solution 3). The above processing procedures in accordance with the present invention accord to a mode named “continually in, continually or intermittently out when having a certain amount”.

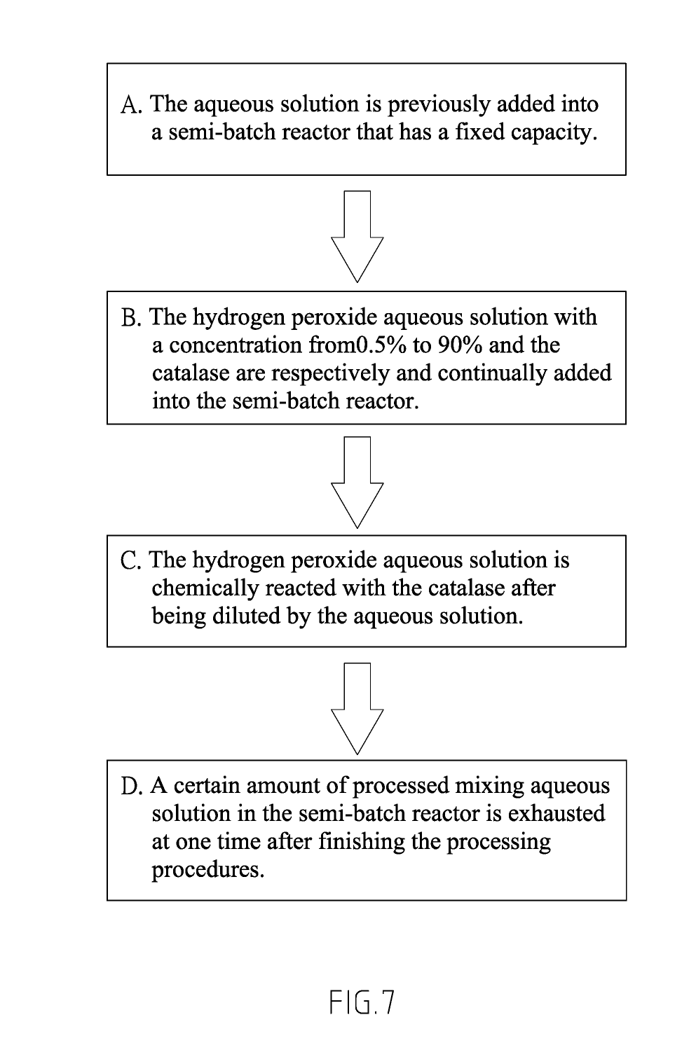

With reference to FIGS. 6 and 7 that show a fourth preferred embodiment of the method in accordance with the present invention, the steps of the fourth embodiment are similar to that of the third embodiment, wherein the different between the third embodiment and the fourth embodiment is the exhaust step. In this embodiment, the semi-batch reactor 1 exhausts the processed mixing aqueous solution with a certain amount once.

As described above, the four embodiments of the present invention include the following advantages.

1. Based on the high catalytic characteristic of the catalase for processing the hydrogen peroxide aqueous solution, the aqueous solution and the catalase are mixed and form a catalase mixing aqueous solution in the semi-batch reactor with a fixed capacity. Then, the hydrogen peroxide aqueous solution and the catalase are added into the semi-batch reactor such that the catalase mixing aqueous solution and the hydrogen peroxide aqueous solution are safely chemically reacted to form catalase and hydrogen peroxide aqueous solution that has a low concentration relative to the original hydrogen peroxide aqueous solution.

2. The heating rate and the boost rate of the semi-batch reactor are effectively reduced for processing the hydrogen peroxide aqueous solution in a safe condition.

3. The capacity X of the semi-batch reactor 1 is adjusted in moderation for providing a buffer to the temperature and pressure of the reacting system for safely processing the hydrogen peroxide aqueous solution.

4. The capacity of the semi-batch reactor can be adjusted relative to the required processing speed of the hydrogen peroxide aqueous solution.

5. After processing several batches, the difference of total volume of each batch is small, that is, only the first batch needs to be added aqueous solution and the processed mixing aqueous solution is used as the necessary aqueous solution of the next batch. Based on the high catalytic characteristic of the catalase for processing the hydrogen peroxide aqueous solution, the chemical reaction of the catalase and the hydrogen peroxide aqueous solution that has a concentration from 0.5% to 90% is transformed as a chemical reaction of the catalase and the low concentration hydrogen peroxide aqueous solution. The Volume percentage of the adding amount of the aqueous solution according to the total process amount is gradually reduced relative number of the batch. After processing tens batches, The Volume percentage of the adding amount of the aqueous solution according to the total process amount is gradually reduced less than 1%.

Although the invention has been explained in relation to its preferred embodiment, it is to be understood that many other possible modifications and variations can be made without departing from the spirit and scope of the invention as hereinafter claimed.

We claim:

1. A processing method for waste hydrogen peroxide aqueous solution that has a concentration from 0.5% to 90%, comprising the following steps:
A. aqueous solution and the catalase previously added into a semi-batch reactor that has a fixed capacity for forming catalase mixing aqueous solution;
B. hydrogen peroxide aqueous solution with a concentration from 0.5% to 90% and the catalase respectively added into the semi-batch reactor at the same time; and
C. the hydrogen peroxide aqueous solution chemically reacted with the catalase after being diluted with the aqueous solution for effectively removing the hydrogen peroxide in the hydrogen peroxide aqueous solution and forming water, oxygen and thermal energy, the semi-batch reactor selectively stopped when at least one of a pressure value, a temperature value and a concentration value of the hydrogen peroxide in the semi-batch reactor is over a pre-set value.

2. The processing method as claimed in claim 1, wherein, in step A, an adding amount of the catalase aqueous solution is from 10 vol % to 90 vol % relative to the capacity of the semi-batch reactor.

3. The processing method as claimed in claim 2, wherein, in step A, the adding concentration of the catalase is 0.05 vol % to 2 vol % relative to the catalase mixing aqueous solution.

4. The processing method as claimed in claim 3, wherein, in step B, an adding rate of the hydrogen peroxide aqueous solution is 0.005 vol %/min to 2 vol %/min relative to the capacity of the semi-batch reactor.

5. The processing method as claimed in claim 4, wherein, in step B, an adding speed of the catalase is 0.05% to 2% relative to an adding speed of the hydrogen peroxide aqueous solution.

6. A processing method for waste hydrogen peroxide aqueous solution that has a concentration from 0.5% to 90%, comprising the following steps:
A. aqueous solution and the catalase previously added into a semi-batch reactor that has a fixed capacity for forming catalase aqueous solution;
B. hydrogen peroxide aqueous solution with a concentration from 0.5% to 90% continually added into the semi-batch reactor; and
C. the hydrogen peroxide aqueous solution chemically reacted with the catalase after being diluted with the aqueous solution for effectively removing the hydrogen peroxide in the hydrogen peroxide aqueous solution and forming water, oxygen and thermal energy, the semi-batch reactor selectively stopped when at least one of a pressure value, a temperature value and a concentration value of the hydrogen peroxide in the semi-batch reactor is over a pre-set value.

7. The processing method as claimed in claim 6, wherein, in step A, an adding amount of the catalase aqueous solution is from 10 vol % to 90 vol % relative to the capacity of the semi-batch reactor.

8. The processing method as claimed in claim 7, wherein, in step A, the adding amount of the catalase is 0.05 vol % to 2 vol % relative to the capacity X of the semi-batch reactor.

9. The processing method as claimed in claim 8, wherein, in step B, an adding rate of the hydrogen peroxide aqueous solution is 0.005 vol %/min to 2 vol %/min relative to the capacity of the semi-batch reactor.

10. A processing method for waste hydrogen peroxide aqueous solution that has a concentration from 0.5% to 90%, comprising the following steps:
A. aqueous solution previously added into a semi-batch reactor that has a fixed capacity;
B. hydrogen peroxide aqueous solution with a concentration from 0.5% to 90% and the catalase respectively added into the semi-batch reactor at the same time; and
C. the hydrogen peroxide aqueous solution chemically reacted with the catalase after being diluted with the aqueous solution for effectively removing the hydrogen peroxide in the hydrogen peroxide aqueous solution and forming water, oxygen and thermal energy, the semi-batch reactor selectively stopped when at least one of a pressure value, a temperature value and a concentration value of the hydrogen peroxide in the semi-batch reactor is over a pre-set value.

11. The processing method as claimed in claim 10, wherein, in step A, an adding amount of the aqueous solution is from 10 vol % to 45 vol % relative to the capacity of the semi-batch reactor.

12. The processing method as claimed in claim 10, wherein, in step B, an adding rate of the hydrogen peroxide aqueous solution is 0.005 vol %/min to 2 vol %/min relative to the capacity of the semi-batch reactor.

13. The processing method as claimed in claim 10, wherein, in step B, the adding speed of the catalase is 0.1% to 4% relative to an adding speed of the hydrogen peroxide aqueous solution in an early stage and the adding speed of the catalase is adjusted to 0.05% to 2% relative to that of the hydrogen peroxide aqueous solution when the total amount of all the solution in the semi-batch reactor 1 is doubled relative to that of the previously added aqueous solution.
